(19) United States
(12) Patent Application Publication
(10) Pub. No.: US 2006/0164161 A1
(43) Pub. Date: Jul. 27, 2006

(54) Correction of quadrature error

(76) Inventor: Ludwig Schwoerer, Hattingen (DE)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 10/526,828

(22) PCT Filed: Sep. 5, 2002
(86) PCT No.: PCT/FI02/00715

§ 371 Date: Sep. 22, 2005

(51) Int. Cl. H04L 27/22

(52) U.S. Cl. 329/304

(57) ABSTRACT

The invention relates to an analog quadrature demodulator (100), which comprises analog domain means for splitting an incoming signal into an in-phase (I) branch signal and a quadrature (Q) branch signal and an analog domain correction circuitry (106, 107) for controllably causing the in-phase (I) branch signal and the quadrature (Q) branch signal to co-operate with each other via the correction circuitry (106, 107) so as to correct the quadrature error.

### FIELD OF THE INVENTION

The invention relates to analog quadrature demodulation. Especially, the invention relates to correction of quadrature error in analog quadrature demodulators.

### BACKGROUND OF THE INVENTION

In communication systems information to be sent from a transmitter to a received is typically modulated by a suitable modulation method. In quadrature amplitude modulation (QAM) two sinusoidal carriers, one of which being 90 degrees out of phase with respect to the other, are used to transmit information over a physical channel. Each carrier can be modulated independently at the transmitter, transmitted over the same frequency band and separated by demodulation at the receiver. The two carriers are referred to as an I-carrier (in-phase) and a Q-carrier (quadrature phase).

By the term analog quadrature demodulator is meant a demodulator in which demodulation is implemented by analog circuitry and in which a received signal is split into I- and Q-components by analog means (contrary to digital means). A significant problem concerning analog quadrature demodulators of this kind is the occurance of so called quadrature error. Quadrature error means the deviation from the ideal phase shift of 90 degrees between I- and Q-signals. If quadrature error occurs the probability that the transmitted information is detected correctly decreases.

Quadrature error is often due to non-ideal performance of the demodulator. Especially, a phase shifter which is used for providing a 90 degrees phase shift between I- and Q-signal branches of the demodulator may not be stable over the whole used frequency region.

Therefore, there is a need to find a solution for correcting the error so that the phase shift between I- and Q-signals at the reception is as close to 90 degrees as possible.

According to one solution quadrature error is corrected by digitally determining the quadrature error, generating a correction signal and adjusting accordingly the phase shifter which provides the 90 degrees phase shift between I- and Q-signal branches of the demodulator. However, adjusting the phase shifter is a complex task to do.

### SUMMARY OF THE INVENTION

It is an object of the present invention to provide a solution for correcting quadrature error, wherein, preferably, the adjustment of the phase shifter can be completely avoided.

According to a first aspect of the invention there is provided a method for correcting quadrature error in an analog quadrature demodulator, the method comprising the steps of:

splitting an incoming signal in the analog quadrature demodulator into an in-phase (I) branch signal and a quadrature (Q) branch signal; and

controllably causing the in-phase (I) branch signal and the quadrature (Q) branch signal to co-operate with each other via an analog domain correction circuitry so as to correct the quadrature error.

In a preferable embodiment of the invention, the analog domain correction circuitry comprises a multiplier and an adder.

Preferably, one of said in-phase (I) branch and quadrature (Q) branch signals is multiplied in said multiplier with a correction signal in order to produce a multiplication result. Preferably, said multiplication result is added in said adder to the other of said in-phase (1) branch and quadrature (Q) branch signals, the quadrature error being thereby corrected. Preferably, said adding is performed as a subtraction.

In a preferable embodiment of the invention, said correction signal is generated in digital domain and is fed back to the analog quadrature demodulator so as to form a correction loop.

According to a second aspect of the invention there is provided an analog quadrature demodulator comprising:

analog domain means for splitting an incoming signal into an in-phase (I) branch signal and a quadrature (Q) branch signal; and

an analog domain correction circuitry for controllably causing the in-phase (I) branch signal and the quadrature (Q) branch signal to co-operate with each other via said correction circuitry so as to correct a quadrature error.

According to a third aspect of the invention there is provided a device comprising an analog quadrature demodulator, the device comprising:

analog domain means in the analog quadrature demodulator for splitting an incoming signal into an in-phase (I) branch signal and a quadrature (Q) branch signal; and

an analog domain correction circuitry for controllably causing the in-phase (I) branch signal and the quadrature (Q) branch signal to co-operate with each other via said correction circuitry so as to correct a quadrature error.

Dependent claims contain preferable embodiments of the invention. The subject matter contained in dependent claims relating to a particular aspect of the invention is also applicable to other aspects of the invention.

### BRIEF DESCRIPTION OF THE DRAWINGS

Embodiments of the invention will now be described by way of example with reference to the accompanying drawings in which:

FIG. 1 shows an analog quadrature demodulator according to a preferred embodiment of invention;

FIG. 2 shows the generation of a correction signal according to a preferred embodiment of the invention; and

FIG. 3 shows a device according to a preferred embodiment of the invention.

### DETAILED DESCRIPTION

In the following description of the various preferred embodiments, reference is made to the accompanying drawings in which is shown by way of illustration various exemplary embodiments in which the invention may be practiced. It is to be understood that other embodiments may be utilized and structural and functional modifications may be made without departing from the scope of the present invention.

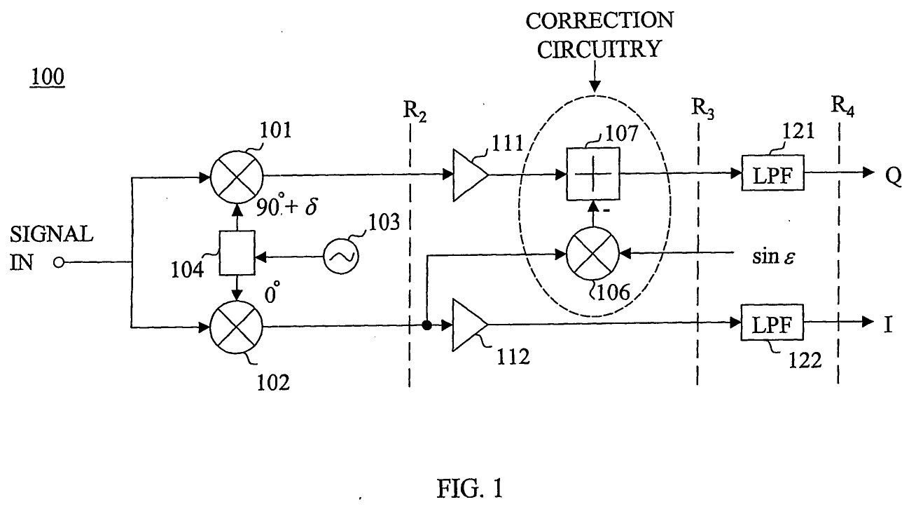

FIG. 1 shows an analog quadrature demodulator according to a preferred embodiment of the invention. A modulated analog signal transmitted by a transmitter and received at the demodulator 100 is of the form:
I cos(2πf_{c}t)+Q sin(2πf_{c}t), (1)
wherein I indicates the amplitude of an in-phase signal component (I) and Q indicates the amplitude of a quadrature phase signal component (Q), f, indicates carrier frequency and t indicates time.

The received signal is split into two substantially identical signals one of which is conveyed to a first input of a first down conversion mixer 101 and the other of which is conveyed to a first input of a second down conversion mixer 102. The signal branch along which the first down conversion mixer 101 resides is called a Q-branch and the signal branch along which the second down conversion mixer 102 resides is called an I-branch.

A local oscillator 103 generates a local oscillator signal. In this embodiment, the local oscillates at a frequency f_{osc} which is the same as the carrier frequency f_{c}. The local oscillator signal is conveyed to a phase shifter 104 which shifts the phase of the local oscillator signal by 90 degrees. The phase shifted local oscillator signal is conveyed to a second input of the first down conversion mixer 101. Additionally, the local oscillator signal is conveyed, with a 0 degree phase shift, from the phase shifter 104 to a second input of the second down conversion mixer 102 so that the phase difference between signals conveyed to the second inputs of mixers 101 and 102 is 90 degrees.

The first down conversion mixer 101 mixes the Q-branch signal which arrives at it via its first input with the phase shifted local oscillator signal in order to generate a baseband Q-signal component. Correspondingly, the second down conversion mixer 102 mixes the I-branch signal which arrives at it via its first input with the local oscillator signal in order to generate a baseband I-signal component.

The mathematical expression illustrating the mixing process (in an ideal case) is as follows:

$$\begin{matrix}[ I cos ( 2 π {f}_{c} t ) + Q sin ( 2 π {f}_{c} t ) ] \cdot {ⅇ}^{j ( 2 π {f}_{c} t )} = \\ [ I cos ( 2 π {f}_{c} t ) + Q sin ( 2 π {f}_{c} t ) ] \cdot [ cos ( 2 π {f}_{c} t ) + j sin ( 2 π {f}_{c} t ) ]\end{matrix} \qquad ( 2 )$$

wherein e^{j(2πf}^{_{c}}^{t}) indicates the local oscillator signal and j indicates the imaginary unit.

However, due to non-idealities (mostly or entirely of the phase shifter 104), there is assumed to occur a quadrature error δ which is substantially the same as the deviation from the ideal phase shift of 90 degrees between the phase shifted local oscillator signal conveyed to mixer 101 and the local oscillator signal conveyed to mixer 102. If, for example, the actual phase shift between the phase shifted local oscillator signal conveyed to mixer 101 and the local oscillator signal conveyed to mixer 102 is 92.1 degrees, the quadrature error δ is then 2.1 degrees.

The (complex) baseband signal at the intersection R₂ (i.e. at the output of the mixers 101 and 102) is of the form:

$$[ I cos ( 2 π {f}_{c} t ) + Q sin ( 2 π {f}_{c} t ) ] \cdot [ cos ( 2 π {f}_{c} t ) + j sin ( 2 π {f}_{c} t + δ ) ] = I {cos}^{2} ( 2 π {f}_{c} t ) + Q sin ( 2 π {f}_{c} t ) \cdot cos ( 2 π {f}_{c} t ) + j [ \begin{matrix}I cos ( 2 π {f}_{c} t ) \cdot sin ( 2 π {f}_{c} t + δ ) + \\ Q sin ( 2 π {f}_{c} t ) \cdot sin ( 2 π {f}_{c} t + δ )\end{matrix} ] = {\underbrace{[ \frac{1}{2} I ( 1 + cos ( 4 π {f}_{c} t ) ) + \frac{1}{2} Q sin ( 4 π {f}_{c} t ) ]}}_{\hat{I}} + j {\underbrace{[ \begin{matrix}I ( \frac{1}{2} sin ( 4 π {f}_{c} t ) cos δ + \frac{1}{2} sin δ + \frac{1}{2} cos ( 4 π {f}_{c} t ) sin δ ) + \\ Q ( \frac{1}{2} cos δ - \frac{1}{2} cos ( 4 π {f}_{c} t ) cos δ + \frac{1}{2} sin ( 4 π {f}_{c} t ) sin δ )\end{matrix} ]}}_{\hat{Q}} \qquad ( 3 )$$

wherein Î indicates the real part of the signal and \hat{Q} indicates the imaginary part.

The output of the first down conversion mixer 101 is conveyed to a first amplifier 111 in order to amplify the signal travelling along the Q-branch. Similarly, the output of the second down conversion mixer 102 is conveyed to a second amplifier 112 in order to amplify the signal travelling along the I-branch.

According to the preferred embodiment shown in FIG. 1, there is provided a correction circuitry in order to correct the quadrature error δ. In this embodiment, the correction circuitry comprises a multiplier 106 and an adder 107. The signal from the output of the second down conversion mixer 112 is conveyed (in addition to the second amplifier 112) to a first input of the multiplier 106. To a second input of the multiplier 106 is conveyed a correction signal sin ε. How the correction signal sin ε is generated is explained later. The multiplier 106 multiplies (i.e. mixes) said signals. The mixing result (i.e. the output of multiplier 106) is conveyed to a first inverted input of the adder 107 and the amplified Q-branch signal is conveyed from the output of the first amplifier 111 to a second input of the adder 107.

The adder 107 sums the signals arriving at its inputs. Since the first input is inverted the adder essentially subtracts the signal at the first input from the signal at the second input. The (complex) baseband signal at the intersection R₃ (i.e. at the output of the adder 107 and the second amplifier 112) is, thus, of the form:

$$\hat{I} + j ( \hat{Q} - \hat{I} sin ɛ ) = [ \frac{1}{2} I ( 1 + cos ( 4 π {f}_{c} t ) ) + \frac{1}{2} Q sin ( 4 π {f}_{c} t ) ] + j [ \begin{matrix}\frac{1}{2} I ( ( sin δ - sin ɛ ) + cos ( 4 π {f}_{c} t ) ( sin δ - sin ɛ ) + sin ( 4 π {f}_{c} t ) cos δ ) + \\ \frac{1}{2} Q ( cos δ - cos ( 4 π {f}_{c} t ) cos δ + sin ( 4 π {f}_{c} t ) ( sin δ - sin ɛ ) )\end{matrix} ] \qquad ( 4 )$$

The output of the adder 107 is conveyed to a first low pass filter 121 and the output put of the second amplifier 112 is conveyed to a second low pass filter 122. The passband of the low pass filters 121 and 122 is such that, in terms of equation (4), all terms with 4πf_{c}t are eliminated. Therefore, the (complex) baseband signal at the intersection R₄ (i.e. at the output of the low pass filters 121 and 122) is of the form:

$$\frac{1}{2} I + j \frac{1}{2} Q cos δ + j \frac{1}{2} I ( sin δ - sin ɛ ) \qquad ( 5 )$$

wherein

$$\frac{1}{2} I$$

represents the baseband I-branch signal,

$$j \frac{1}{2} Q cos δ$$

represents the baseband Q-branch signal and

$$j \frac{1}{2} I ( sin δ - sin ɛ )$$

represents an error term.

If the correction signal sin ε approaches sin δ, the error term approaches zero. This should be the case in a preferred embodiment of the invention (as explained later on). Therefore, when the error term approaches zero, it is immediately apparent that only a small balance error (i.e. an amplitude (gain) difference between the I- and Q-branch signal) remains, but the quadrature error (which is typically due to non-idealities of the phase shifter 104) has been well corrected since there is no imaginary part in the I-branch signal and there is no real part in the Q-branch signal (and therefore the phase shift between the I-branch signal and the Q-branch signal becomes 90 degrees). The balance error mentioned in the foregoing can be taken care of by a well known balance correcting loop (not shown).

Depending on the device in which the analog quadrature demodulator resides, the output of the low pass filters 121 and 122 (i.e. the baseband I- and Q-signal components) is conveyed to an appropriate block of the device.

The device may be a fixed receiver or a mobile handheld receiver. It may be a digital receiver, which comprises, in addition to the analog quadrature demodulator, a digital demodulator, such as a digital demodulator operating in accordance with an OFDM (Orthogonal Frequency Division Multiplex) principle. One example of such a receiver is a DVB-T (Digital Video Broadcasting-Terrestrial) receiver which contains, in addition to an analog quadrature demodulator, a digital OFDM based demodulator, i.e. a COFDM (Coded Orthogonal Frequency Division Multiplex) demodulator. In such a digital receiver analog baseband I- and Q-signal components are, typically, first converted into digital form in an ADC (Analog-to-Digital Converter) block before entering the digital demodulator. Alternatively, the receiver may be a digital receiver operating in accordance with ISDB-T (Integrated Services Digital Broadcasting-Terrestrial) standard. The device may have a cellular network capability in order to perform interactive communication with a cellular network such as a cellular telephone network.

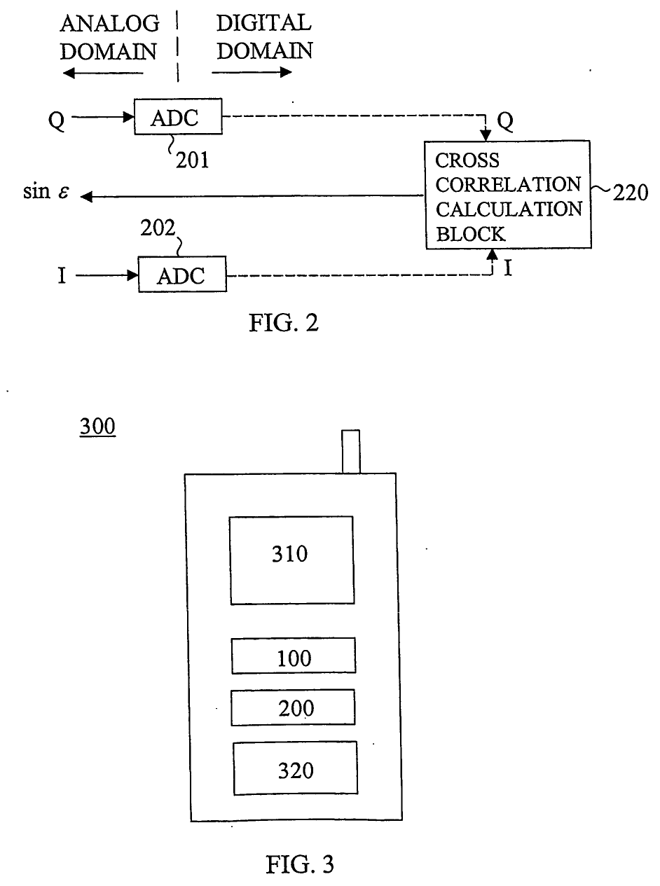

The generation of the correction signal sin e (one of the input signals of the multiplier 106) will now be explained with reference to FIG. 2. The generation can be done either in the analog or digital domain. If it is done in analog domain, an analog block which calculates the quadrature error and produces the signal sin δ is needed (not shown).

In the preferred embodiment of FIGS. 1 and 2, the signal sin ε is generated in the digital domain (see FIG. 2) and is then fed back to the multiplier 106 (see FIG. 1) residing in the analog domain.

In terms of FIG. 2, the baseband Q-signal component coming from the first low pass filter 121 (see FIG. 1) is conveyed to a first ADC block 201 which converts the baseband Q-signal component from analog into digital form. The digital baseband Q-signal component is conveyed to a cross correlation calculation block 220.

Similarly, the baseband I-signal component coming from the second low pass filter 122 (see FIG. 1) is conveyed to a second ADC block 202 which converts the baseband I-signal component from analog into digital form. The digital baseband I-signal component is also conveyed to the cross correlation calculation block 220.

The lines from the ADC blocks 210 and 202 to the cross correlation calculation block 220 are drawn in FIG. 2 as dotted lines in order to indicate that it may well be appropriate that the baseband I- and Q-signal components are not directly taken from the ADC blocks 201 and 202 to the cross correlation calculation block 220, but further processing, known as such to a person skilled in the art, can be applied to the signal components in between.

The cross correlation calculation block 220 calculates the cross correlation of the I- and Q-signal components. The cross correlation may be calculated for digitized signals as follows:

$${lim}_{n \to ∞} \frac{{\sum }_{i = 0}^{n} I ( i ) \cdot ( I ( i ) ( sin δ - sin {ɛ}_{i} ) + Q ( i ) cos δ )}{n} = {lim}_{n \to ∞} \frac{{\sum }_{i = 0}^{n} ( {[ I ( i ) ]}^{2} ( sin δ - sin {ɛ}_{i} ) + I ( i ) \cdot Q ( i ) cos δ )}{n} = {\overline{I}}^{2} sin δ \qquad ( 6 )$$

wherein \overline{I}² indicates average power of the I-signal and i indicates an index running from 0 to n, wherein n approaches infinity. In practice, the cross correlation calculation is not extended to infinity, but the output of the cross correlation calculation still converges to \overline{I}² sin δ.

It can be seen that the calculation of the cross correlation gives an output proportional to sin δ. On the other hand, the calculation of cross correlation of the I- and Q-signal components can be considered an error measurement since it indirectly gives the quadrature error δ. Actually, if the quadrature error δ is small, the approximation sin δ≈δ applies. (When the approximation applies the calculation of the cross correlation thus gives an output directly proportional to δ.)

The correction signal sin ε is taken from the cross correlation calculation block 220 and fed back to the to the multiplier 106. In other words, the output of the cross correlation calculation (the output being proportional to sin δ) is used, after further processing known as such, as the correction signal sin ε. Thus, a correction loop, such as an I-loop (Integrator) or PI-loop (Proportional Integrator)), is formed, wherein the remaining error after correction is measured in the cross correlation calculation block 220 and is fed back with an appropriate time constant to the correction circuitry which further corrects the error. In this way the quadrature error is forced towards zero.

The cross correlation calculation block 220 may be part of a digital demodulator. It may be implemented as a separate physical block. Alternatively, it may be integrated into another block or may be implemented by software in a digital signal processor or similar.

In the foregoing, it has been described that it would be the I-signal component that is conveyed to the multiplier 106. Furthermore, it has been described that the mixing result of the multiplier 106 would be conveyed to the first inverted input of the adder 107 and that the amplified Q-branch signal from the first amplifier 111 would be conveyed to the second input of the adder 107. In an alternative embodiment, the places of the signal components are changed so that it is the Q-signal component (right before the first amplifier 111) that is conveyed to an adder to be mixed with a correction signal. And, the mixing result is conveyed to a first input of an adder and the signal conveyed to a second input of the adder is the I-branch signal from the second amplifier 112 (instead of the amplified Q-branch signal from the first amplifier 111).

In the foregoing, it has also been described in a preferred embodiment of the invention that the correction circuitry would comprise the multiplier 106 and the adder 107. In an alternative preferred embodiment, the multiplier 106 is replaced by an adjustable amplifier. This is possible since the correction signal (or factor) sin ε, which converges to sin δ, is quasi-static. Accordingly, an amplifier the input signal of which is the baseband I-branch signal Î and the amplification factor of which is sin ε gives the same output than the multiplier 106, i.e. Î sin ε. Therefore, the multiplier 106 can be replaced by an (adjustable) amplifier without any substantial further modification to the device. The amplifier's amplification factor is controlled by the received correction signal sin ε.

FIG. 3 illustrates a mobile handheld device 300 according to a preferred embodiment of the invention. The device 300 is a combined DVB-T receiver and a mobile phone. The device 300 comprises an analog quadrature demodulator 100 as well as a COFDM digital demodulator 200. The device further has a display 310 and a separate transceiver 320 for interactive communication with a conventional mobile communications network cellular telephone network. The analog quadrature demodulator 100 has the correction circuitry of FIG. 1. The digital demodulator 200 is programmed such that it generates the above mentioned correction signal sin ε and provides said signal for the analog quadrature demodulator 100 which corrects a quadrature error with the aid of said correction circuitry.

The present invention provides a rather simple mechanism of correcting quadrature error, typically caused be a non-ideal phase shifter (FIG. 1, reference number 104), in analog quadrature demodulators. Especially, the invention makes it possible to avoid the complex adjustment of the phase shifter of prior quadrature error correction solutions. Although the present description describes an analog quadrature demodulator operating according to a direct conversion principle, the invention is not restricted to this type of analog quadrature demodulators. The only requirement with this respect is that splitting into I- and Q-branch signal is done in analog domain.

Particular implementations and embodiments of the invention have been described. It is clear to a person skilled in the art that the invention is not restricted to details of the embodiments presented above, but that it can be implemented in other embodiments using equivalent means without deviating from the characteristics of the invention. The scope of the invention is only restricted by the attached patent claims.

What is claimed is:

1. A method for correcting quadrature error in an analog quadrature demodulator (100), the method comprising the steps of:
splitting an incoming signal in the analog quadrature demodulator (100) into an in-phase (I) branch signal and a quadrature (Q) branch signal; and
controllably causing the in-phase (I) branch signal and the quadrature (Q) branch signal to co-operate with each other via an analog domain correction circuitry (106, 107) so as to correct the quadrature error.

2. A method according to claim 1, wherein one of the in-phase (I) branch and quadrature (Q) branch signals is multiplied in a multiplier (106) with a correction signal in order to produce a multiplication result.

3. A method according to claim 2, wherein the multiplier (106) is one of the following: a mixer, an adjustable amplifier.

4. A method according to claim 2, wherein the multiplication result is added in an adder (107) to the other of the in-phase (I) branch and quadrature (Q) branch signals in order to correct the quadrature error.

5. A method according to claim 4, wherein the adding is performed by subtracting the multiplication result and said other of the in-phase (I) branch and quadrature (Q) branch signals from each other.

6. A method according to claim 4, wherein said one of the in-phase (I) branch and quadrature (Q) branch signals is the in-phase (I) branch signal and said other of the in-phase (I) branch and quadrature (Q) branch signals is the quadrature (Q) branch signal.

7. A method according to claim 2, wherein said correction signal is a signal relating to the quadrature error.

8. A method according to claim 2, wherein said correction signal is a signal proportional to sin ε, wherein ε corresponds to the quadrature error.

9. A method according to claim 2, wherein the method further comprises the steps of:
converting the in-phase (I) branch signal and the quadrature (Q) branch signal from analog into digital domain;
generating said correction signal based on a cross correlation calculation of the digital domain in-phase (I) branch and quadrature (Q) branch signals; and
feeding back the correction signal generated in the digital domain to the analog domain correction circuitry (106, 107).

10. An analog quadrature demodulator (100) comprising:
analog domain means for splitting an incoming signal into an in-phase (I) branch signal and a quadrature (Q) branch signal; and
an analog domain correction circuitry (106, 107) for controllably causing the in-phase (I) branch signal and the quadrature (Q) branch signal to co-operate with each other via said correction circuitry so as to correct a quadrature error.

11. A device (300) comprising an analog quadrature demodulator (100), the device comprising:
analog domain means in the analog quadrature demodulator (100) for splitting an incoming signal into an in-phase (1) branch signal and a quadrature (Q) branch signal; and
an analog domain correction circuitry (106, 107) for controllably causing the in-phase (I) branch signal and the quadrature (Q) branch signal to co-operate with each other via said correction circuitry so as to correct a quadrature error.

12. A device according to claim 11, wherein the device (300) operates in accordance with an OFDM (Orthogonal Frequency Division Multiplex) principle.

13. A device according to claim 11, wherein the device (300) is one of the following: a DVB-T (Digital Video Broadcasting-Terrestrial) receiver, an ISDB-T (Integrated Services Digital Broadcasting-Terrestrial) receiver.

14. A device according to claim 11, wherein the device (300) has a cellular network capability (310) in order to perform interactive communication with a cellular network, such as a cellular telephone network.

15. A device according to claim 11, wherein the device (300) is a mobile device.

16. A device according to claim 11, wherein the device (300) contains, in addition to the analog quadrature demodulator (100), a digital demodulator (200) for generating a correction signal to be fed back to the analog quadrature demodulator so as to form a correction loop, such as an I-loop (Integrator) or PI-loop (Proportional Integrator), for forcing the quadrature error towards zero.
